(19) United States
(12) Patent Application Publication
(10) Pub. No.: US 2015/0249910 A1
(43) Pub. Date: Sep. 3, 2015

(54) WIRELESS NETWORK PROMOTIONS

(71) Applicant: Carlos V. Roman, Fort Lauderdale, FL (US)

(72) Inventor: Carlos V. Roman, Fort Lauderdale, FL (US)

(21) Appl. No.: 14/194,664

(22) Filed: Feb. 28, 2014

(51) Int. Cl. H04W 4/18

(52) U.S. Cl. CPC H04W 4/18

(57) ABSTRACT

A method and system is provided for offering new wireless informational content that will appear on mobile devices when a user browses for wireless network hotspots. The informational content offers a more user friendly/intelligent way to display available Wi-Fi networks by including text, image or video in each Wi-Fi network description that is in range of a mobile device by displaying this new content in either a static or dynamic display format.

### RELATED APPLICATIONS

This application claims benefit of priority to U.S. Provisional Patent Application No. 61/958,752 entitled WIRELESS NETWORK PROMOTIONS, filed Aug. 29, 2013, the aforementioned priority application being hereby incorporated by reference in its entirety.

### TECHNICAL FIELD

The present invention generally relates to wireless communication devices. In particular, the present invention relates to methods for wirelessly delivering targeted information to a mobile device.

### BACKGROUND ART

FIG. 1, depicts a simplified block diagram for a wireless consumer communication network which has gained popularity across a broad spectrum of users due to the implementation of this technology in mobile devices such as smartphones, tablets, handheld devices and personal computers. Additionally, more and more consumer related applications for this technology are being devised for implementation with such devices. However, little has been done to customize content during the delivery to mobile devices when a consumer receives wireless hotspot information.

Currently, the consumer is offered sparse information while browsing for wireless network hotspots wherein the only information offered is a cryptic description of the hotspot and an indication of whether or not it is secured. This sparse information is the first thing a user sees on their mobile devices screen before they are even connected to the Internet. Basically, the information provided to the user is displayed presently only for internet connection purposes. FIG. 2 shows a screenshot 70 of a website that currently uses non-intelligent network descriptions for use in internet access, file sharing and other purposes. However, the present invention discloses a method for delivering expanded content by offering intelligent network descriptions during hotspot selection.

Therefore, a need exists in the art for a means by which a content provider may provide targeted content to a mobile electronic device capable of receiving such content by a user when they receive hotspot connectivity information.

### SUMMARY OF THE INVENTION

A method and system is provided for offering new wireless informational content that will appear on mobile devices when a user browses for wireless network hotspots. The informational content offers a more user friendly/intelligent way to display available Wi-Fi networks by including text, image or video in each Wi-Fi network description that is in range of a mobile device by displaying this new content in either a static or dynamic display format.

### DESCRIPTION OF THE DRAWINGS

In the accompanying drawings:

FIG. 1 depicts a simplified block diagram of one example operating environment wherein embodiments of the present invention may be practiced;

FIG. 2 shows a screenshot of a website that currently uses non-intelligent network descriptions for use in internet access, file sharing and other purposes;

FIG. 3 depicts a flow chart illustrating the method for providing content to a mobile device using Wi-Fi network hotspots;

FIG. 4 is a smartphone illustration having a display for viewing available Wi-Fi hotspots;

FIG. 5 illustrates the smartphone display showing SIDD descriptions for each Wi-Fi hotspot and indicating for each W-Fi hotspot whether it is within range;

FIG. 6 illustrates the smartphone display showing available security and authentication protocols for connecting to a Wi-Fi hotspot;

FIG. 7 illustrates another embodiment of a smartphone display showing available security and authentication protocols for connecting to a Wi-Fi hotspot; and

FIG. 8 illustrates yet still another embodiment of a smartphone display showing available security and authentication protocols for connecting to a Wi-Fi hotspot.

### DESCRIPTION OF EMBODIMENTS

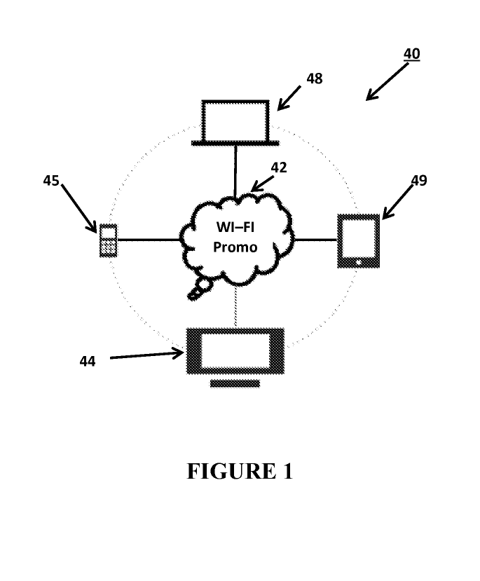

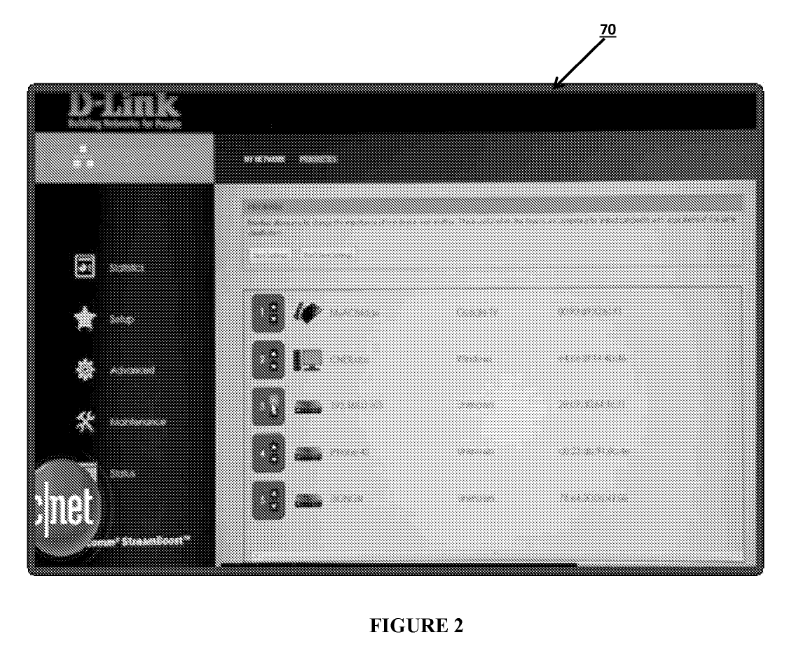

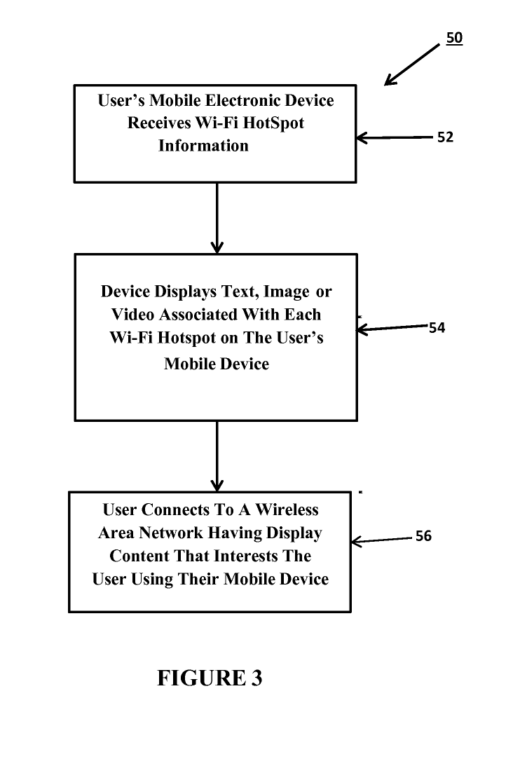

FIGS. 1 through 8 depict various features of embodiments of the present invention which is generally directed to a method and system by which informational content is provided when a user enables their mobile device to display available WI-FI networks. For purposes of discussion it should be understood that mobile devices as used throughout this specification is a generic term used to refer to a variety of devices that allow people to access data and information from where ever they are. This includes cell phones and portable devices. Presently, users are presented with available wireless networks consisting of a dummy display of SIDD descriptions within range of the user's mobile device. Referring to FIG. 3, a method of is shown 50 wherein when the user turns on their mobile device such as for example an iPhone or Android, for enabling a wireless network 52, the mobile device picks up and displays 54 signals of available networks known as Wi-Fi hotspots within range. The user connects to a wireless area network having display content that interests the user by using their mobile device to make the selection 56.

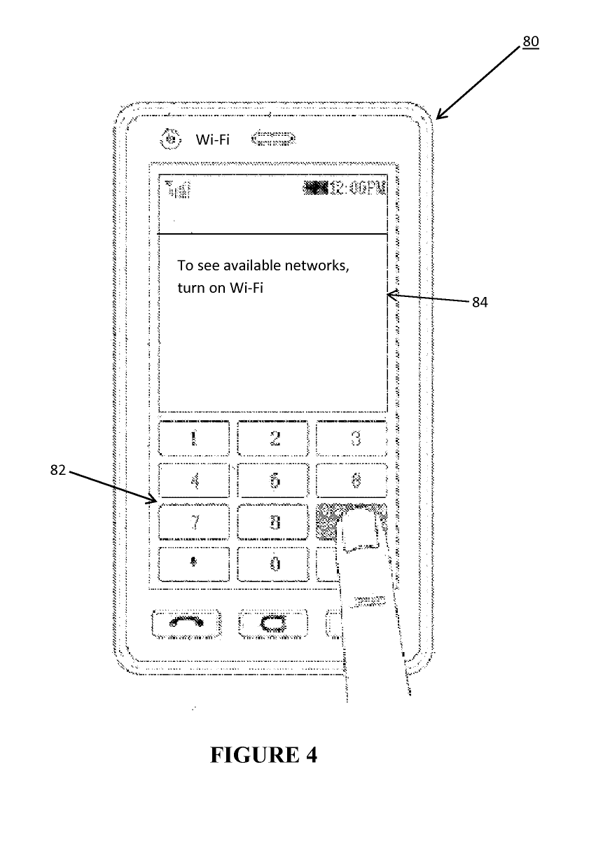

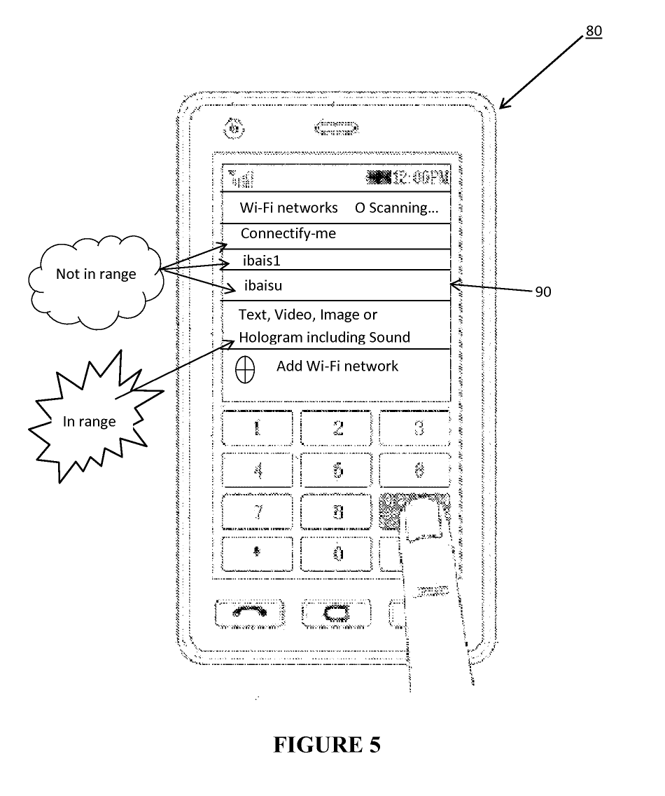

Turning now to FIGS. 4 and 5, when the user has their hotspot locator enabled 82 a screen 84 on their device 80 will currently display various hotspots within range; typically in the following SIDD format:
King_{—}4786 Icon: Private Network|Locked|Range Symbol/Digits
DairyQ_{—}7756 Icon: Private Network|I Locked|Range Symbol/Digits
City of Hollywood Icon: Public Network|Unlocked|Range Symbol/Digits
Taco_StoreID123 Icon: Private Network|Locked|Range Symbol/Digits

FIG. 5 illustrates that the display 90 also indicates which hot spots are not within range of the user's mobile device 80 allowing the user to choose only that hotspot that is within range wherein the in range hotspot may be represented by a display of text, video, image or hologram that could also include sound.

Turning once again to FIG. 1 and in accordance with the present invention, a new wireless content 42 is disclosed that may be text, image or video which will appear on connected devices 44, 45, 48 and 49 thereby offering for the first time a more user friendly/intelligent way to display available networks 40 while simultaneously providing new and different content in the format of either text, image or video to the mobile or connected devices wherein the content may be either statically or dynamically displayed. To illustrate this and using the example of the old or prior art format shown above, a new display SIDD format in accordance with the present invention would look for each hotspot displayed to the user on their mobile device as follows:
Burger King (text, image or video) Icons: Coupon/Deal|Locked|Range Symbol/Digits
Dairy Queen (text, image or video) Icons: Coupon/Deal|Locked|Range Symbol/Digits
City of Hollywood (text, image or video) Icons: Promotion|Unlocked|Range Symbol/Digits
Taco Bell (text, image or video) Icons: Coupon/Deal|Locked|Range Symbol/Digits

Though described herein in connection with a mobile device 45 in the form of a wireless-enabled personal device, one of skill in the art, with the benefit of the present disclosure, will appreciate that embodiments of the invention may be practiced in conjunction with other devices 44, 48 and 49 that may include, but are not limited to, personal digital assistants, cellular telephones, personal audio devices, satellite radios, and the like or any combination thereof. Accordingly, the following discussion should not be construed to limit the present invention in any way.

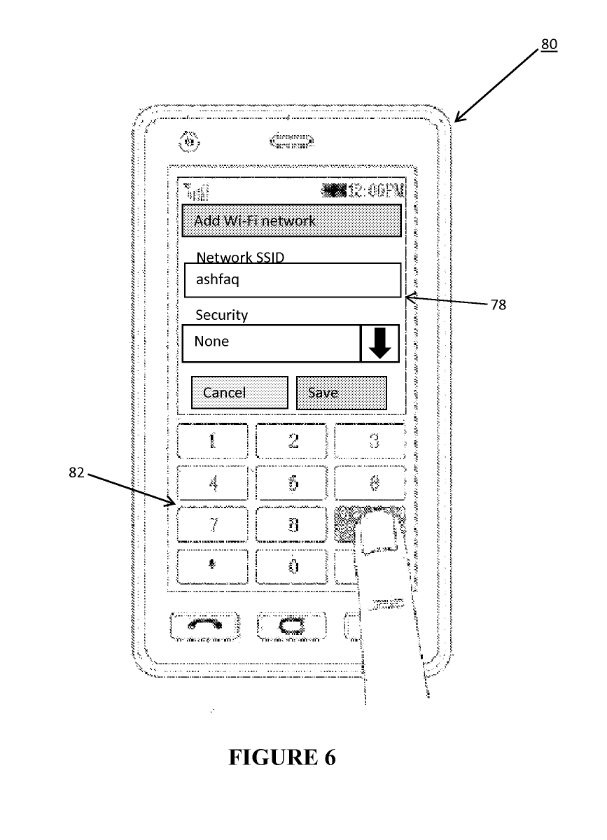

FIG. 6 illustrates the smartphone display 78 showing available security and authentication protocols for connecting 82 to a Wi-Fi hotspot. Embodiments of the invention provide for a mobile device 80 that serves as a platform for the receipt and transmission of secured or unsecured digital content. As used herein, “content” includes digital or analog audio/video/text data in various formats, images in various formats, data transmitted via satellite, cellular networks, the Internet and World Wide Web, and the like or any combination thereof.

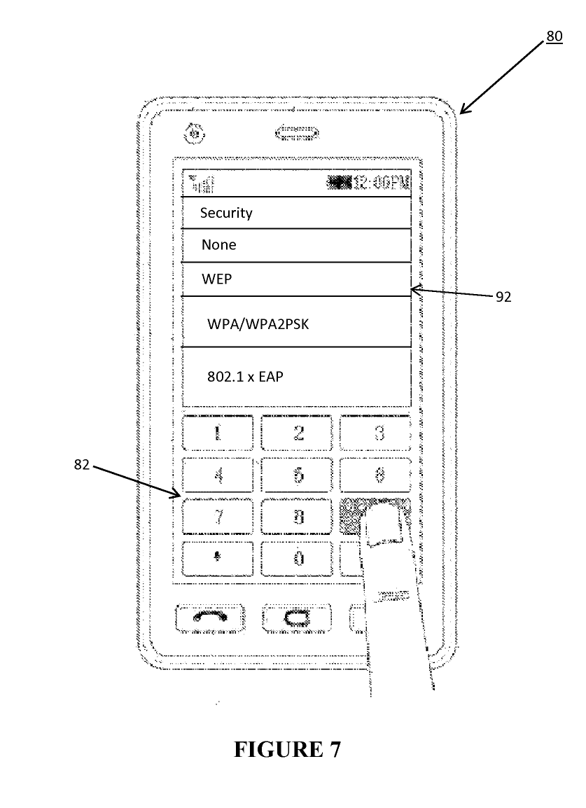

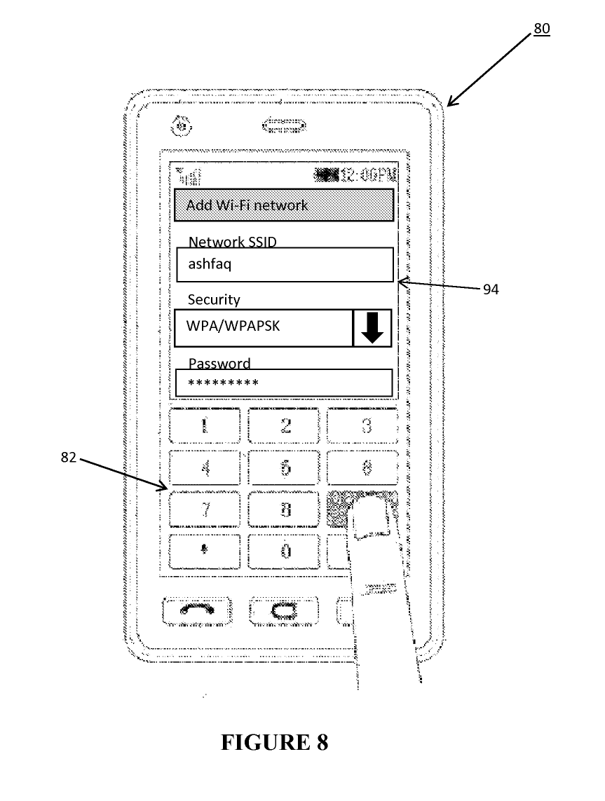

One embodiment of the present invention as shown in FIG. 7 includes a mobile electronic device 80 implemented as 802.11-enabled personal audio/video device that can receive content over a wireless network. Alternately or additionally, the device may be a Bluetooth-enabled device configured to receive content over a personal area network. In general however, the device may receive content over any wireless network capable of transmitting digital information. The content may be delivered by various content providers for selection 82 by the user as is shown by way of example on display 92. Embodiments of the invention may also dock with another device such as a computer for various reasons, e.g. altering stored content, and perform in a similar manner over the computer's connection. FIG. 8 illustrates the device 80 displaying an SSID format 94 for entering 82 a network username and password.

Content may be provided by businesses that may be presented to the user by displaying promotional banners as part of the SSID hotspot description (not shown). Businesses will have real-time analytics available to report devices that are within range at any given day or time. They will also have analytics available to report actions made upon their promotion (i.e. save, social share, text, email and click to connect to network). Additionally, the text, image or video may be presented as a hologram.

In accordance with one embodiment of the invention, there is no cost to the user to participate in receiving new content or promotional items on their wireless network hotspot screen. Businesses or any content provider may participate by subscribing to a wireless network hotspot promotional plan. Therefore, it is envisioned that businesses or content providers that participate will deliver a presentable image to wireless network devices. However, for those businesses or content providers that don't participate they will simply use the basic description settings being left out as a possible non-trusted wireless network or a plain text promotion that user's may not find as appealing as the promotional option that the present invention offers them.

Turning once again to FIG. 3, screenshot image 70 representing a new product from D-Link that currently uses non-intelligent network descriptions. Networks may be used for Internet access, file sharing, and other purposes. The present invention now allows for the ability to leverage these types of new/enhanced marketing opportunities showing intelligent promotions before a trusted connection using the connectivity shown and described in FIGS. 6, 7 and 8.

The device 45 is preferably a network connectable device. The device, for example, may include the ability to wirelessly access multiple types of networks, including 802.11-related wireless networks (e.g., “WiFi”) and others using an antenna (not shown). Alternately or additionally, the device 45 may have access to other wireless networks such as Bluetooth networks, cellular networks, satellite networks, RFID sytems, and/or terrestrial RF networks, including WiMAX, AM, FM, DAB (“digital audio broadcasting”), etc.

Referring once again to FIG. 1, in one embodiment, the device 45 accesses the Internet through a wireless access point (e.g., a WiFi “hotspot”) 42 included as a portion of a network 40. Once connected to the Internet, the device 45 may interact with multiple content providers by receiving Wi-Fi hotspots 42. In another preferred embodiment, the device 45 may access satellite broadcast content over the Internet rather than over a satellite network. The device 45 may also be able to access terrestrial radio broadcasts (digital radio, FM, AM, and the like), as described above. Further, the device 45 can also receive and provide other media content, such as World Wide Web content, television content, video content and the like or any combination thereof, in one embodiment.

It should be understood that the present invention expands the current SIDD description on the WIFI display thereby making it appear more intelligent to the user. Today the SIDD is 32 bits wherein the SIDD displays text only up to 32 bits. Therefore the method of the present invention expands the SIDD to 64, 128 bits and beyond and to allow the SIDD to display more descriptive text, promotional banners and or video that is served up by a content provider without requiring authentication during hotspot displays. The user is able to immediately see these wireless networks within range showing text, promotional banners and video and to connect to that network by performing authentication to that wireless network, save the text, promotional banner or video to their device and social share the text, promotional banner or video (SMS, Facebook, Twitter, Google, etc.).

The content provider may represent a place of business, such as a restaurant, Internet cafe, bookstore, or any other suitable location. In other embodiments, the merchant is representative of other types of locations, both private and public, including museums, government licensing law enforcement locations, military installations, and so forth.

Another type of device 49 is shown in FIG. 1, i.e., a tablet or Ipad. Assuming the content provider wishes to communicate with devices of the type of device 49 and that the desired area for the distribution of promotional content is the extent of the range of the hotspot 42, the device 49 is both the desired device type for promotional content reception and within range for receipt of such content. As such, the content provider has both desires and has the ability to send promotional content, indicated at 42, to the device 49. The device 49 and other devices 44 and 48 in the range of the hotspot 42 are detected and monitored by the content provider through any suitable means, both hardware, and software, to enable such device monitoring and communication.

Note that, while it employs a particular wireless network configuration, i.e., a WiFi network configuration, in other embodiments the content provider may employ other network configurations to transmit promotional content to desired devices. These alternative network configurations include, for example, cellular and satellite networks, to name a few. In the case of cellular or satellite networks, the range over which devices can be contacted for the receipt of promotional content can be larger than what is currently available via WiFi networks. When such a network is used to communicate the promotional material, an alternative means of identifying location is employed. For example, GPS technology can be utilized in one embodiment to determine the particular location of the device when determining whether to send the promotional material.

Moreover, while they are described as consumer devices, the devices can, in other embodiments be considered commercial, governmental, military, or other devices, having varying purposes or functionality. Similarly, the content transmitted to the devices according to their respective locations can be types other than content of a promotional nature. For instance, extreme weather warnings, missing child alerts, traffic or road condition reports, or other location-dependent notices can be transmitted to devices according to their proximity to a particular area or event.

In another embodiment, it is appreciated that device-specific material can be transmitted to certain devices according to their particular configuration. For example, the network components of the content provider may be configured such that devices having a particular purpose, e.g., cell phones, can receive promotional content of one type, while other devices, e.g. personal music devices, can receive another type of promotional content. Further, the nature of the promotional material can be altered according to the time of day, the number of patrons already present at the locale, whether the user of the device receiving the promotional content is a first-time user, etc.

In yet still another preferred embodiment, in the case of a business, the promotional content may be in the form of a coupon that the user of the device 45 may redeem at the content provider or businesses locale. As the coupon is transmitted to the device 45 while the user is in close proximity to the content provider, the user may be more likely to redeem the coupon, thereby enhancing convenience to the user. The coupon in the present embodiment is transmitted from the content provider to the device 45 via the Wi-Fi network 40. This is not meant to limit the present invention to only such a configuration. Indeed, other modes of content transmission are also possible, including infrared, RFID or other RF frequency or optical transmission.

Any of the embodiments described with FIGS. 1 thru 8 may be performed by computers, including general purpose computers, connected (to a network or the Internet) computers, or combinations of client-server computers and/or peer-to-peer terminals. In one embodiment, for example, network 40 is provided on a server, and accessed by a user through a web interface. However, alternatives are possible, including use of standalone computers to provide network 40. In accordance with one deployment, the network may be provisioned as software executing on a server in the cloud. Client device such as mobile phones are provisioned with a client application to connect with the over a network (e.g. the Internet).

It is contemplated for embodiments of the invention to extend to individual elements and concepts described herein, independently of other concepts, ideas or system, as well as for embodiments to include combinations of elements recited anywhere in this application. Although illustrative embodiments of the invention have been described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. This, the absence of describing combinations should not preclude the inventor from claiming rights to such combinations.

In general, the routines executed to implement the embodiments of the invention, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of machine or computer-readable media used to actually effect the distribution. Examples of computer-readable media include but are not limited to recordable type media such as volatile and non-volatile memory devices, USB and other removable media, hard disk drives, optical disks (e.g., Compact Disk Read-Only Memory (CD ROMS), Digital Versatile Disks, (DVDs), etc.), and flash drives, among others.

Although the present invention has been described with reference to specific exemplary embodiments, it will be evident that the various modification and changes can be made to these embodiments without departing from the broader spirit of the invention. Accordingly, the specification and drawings are to be regarded in an illustrative sense rather than in a restrictive sense.

What is claimed is:

1. In a wireless communications network, a method for transmitting content to a user's mobile device, the method comprising:
determining that a mobile electronic device is within a range of one or more wireless communications networks;
displaying a unique promotional text, image or video for each said one or more wireless communications networks as part of their SIDD description; and
connecting to one of said one or more wireless communication networks by the user based on choosing said unique promotional text, image or video of interest.

2. The method of claim 1, wherein the wireless communications network comprises one or more of: an 802.11-based communications network; and a Bluetooth-based communications network.

3. The method for transmitting as defined in claim 1, wherein the wireless communications network is a network capable of transmitting digital information in a 128 bit format.

4. The method for transmitting as defined in claim 3, wherein the content is an electronic coupon that is displayed on a display portion of the mobile electronic device.

5. The method as defined in claim 1, wherein a user of the mobile device forwards the content to a second mobile device.

6. A mobile device capable of receiving and displaying content which may be 64 bits transmitted to the mobile device according to the method of claim 1.

7. In a wireless communications network, a method for transmitting content to one or more mobile devices when a user is browsing wireless network hotspots, the method comprising:
detecting a mobile device near a predetermined location and transmitting the content consisting of text, which is greater than 32 bits to the mobile for that given hotspot.

8. The method for transmitting as defined in claim 7, wherein the content is one or more of:
promotional content, an extreme weather warning, a missing child alert, and a traffic or road condition report.

9. The method as defined in claim 7, wherein detecting a mobile electronic device near a predetermined location comprises determining that the mobile electronic device is within a range of the wireless communications network.

10. The method as defined in claim 7, wherein: the content comprises an electronic coupon that is displayed on a display portion of the mobile electronic device; and the predetermined location comprises a locale of a content provider, wherein the electronic coupon can be redeemed within the content provider's locale by a user of the mobile electronic device.

11. The method as defined in claim 10, further comprising receiving the electronic coupon from the user of the mobile electronic device and providing a discount to the user on a purchase at the content provider's locale.

12. A system for transmitting content to a user's mobile device in a wireless communications network, comprising:
a mobile device for accessing one or more wireless communications networks wherein said one or more wireless communications networks displays a unique promotional text, image or video to said mobile device as part of their SIDD description; and
the user selects one of said one or more wireless communication networks based on choosing a particular said unique promotional text, image or video of interest.

13. The system as defined in claim 12, wherein the wireless communications network comprises one or more of: an 802.11-based communications network and a Bluetooth-based communications network.

14. The system as defined in claim 13, wherein said unique promotional text, image or video is an electronic merchant coupon that is displayed on a mobile device.

15. The system as defined in claim 13, wherein a user of the mobile device forwards said unique promotional text, image or video is a hologram.

16. The system as defined in claim 13, wherein the mobile device is capable of receiving, transmitting and displaying content which may be 64 bits or greater.

17. The system as defined in claim 13, wherein said unique promotional text, image or video may be an extreme weather warning, a missing child alert, and a traffic or road condition report.

18. The system as defined in claim 13, wherein detecting a mobile electronic device near a predetermined location comprises determining that the mobile electronic device is within a range of the wireless communications network.

19. The system as defined in claim 13, wherein the unique promotional text, image or video is an electronic coupon that is displayed on a display portion of the mobile electronic device; and the predetermined location comprises a locale of a content provider, wherein the electronic coupon can be redeemed within the content provider's locale by a user of the mobile electronic device.

20. The system as defined in claim 13, wherein the user of the mobile electronic device receives an electronic coupon providing a discount to the user on a purchase at the content provider's locale.
